(19) United States
(12) Patent Application Publication
(10) Pub. No.: US 2006/0251044 A1
(43) Pub. Date: Nov. 9, 2006

(54) Mobility support for multihome nodes

(76) Inventor: Wassim Haddad, Montreal (CA)

Correspondence Address: SANDRA BEAUCHESNE;Ericsson Canada Inc., Patent Department, 8400 Decarie Blvd., Town Mount Royal, QC, H4P 2N2, CA

(21) Appl. No.: 11/384,305

(22) Filed: Mar. 21, 2006

Related U.S. Application Data
(60) Provisional application No. 60/673,786, filed on Apr. 22, 2005.
(60) Provisional application No. 60/685,396, filed on May 31, 2005.

(51) Int. Cl. H04J 3/24

(52) U.S. Cl. 370/349

(57) ABSTRACT

A method, a correspondent node and a mobile node are provided for allowing setup of a session between the mobile node and the correspondent node using a new unique indicator in lieu of the home address to enable the correspondent node to uniquely identify the mobile node. The correspondent node uses the new unique indicator to identify the session within its Binding Cache Entry table. The mobile node may change its selection of a home address without impacting its ongoing session. Change of a home address may occur when the mobile node selects a new home agent to serve an ongoing session, or when the mobile node selects a new access interface during an ongoing session.

### PRIORITY STATEMENT UNDER 35 U.S.C. S.119(e) & 37 C.F.R. S.1.78

This non-provisional patent application claims priority based upon the prior U.S. provisional patent application entitled “Anonymity Extension for the Optimized Mobile IPv6 (OMIPv6) Protocol”, application No. 60/673,786, filed Apr. 22, 2005, in the names of Wassim Haddad and Suresh Krishnan, and upon the prior U.S. provisional patent application entitled “Mobility Support for Multi-Homed Nodes”, application No. 60/685,396, filed May 31, 2005, in the name of Wassim Haddad.

### BACKGROUND OF THE INVENTION

1. Field of the Invention

The present invention relates to a method, a mobile node and a correspondent node, for supporting multihoming.

2. Description of the Related Art

Mobile IP version 4 (Mobile IPv4, Mobile IP, MIPv4 or MIP) and the current version of Mobile IPv6 (MIPv6) are built to provide mobility to a host or Mobile Node (MN). The other nodes, usually referred to as Correspondent Nodes (CN) 120, are usually seen as fixed hosts. Reference is now made to the drawings where FIG. 1 shows a MIPv6 network architecture as suggested by the current MIPv6 specification found in an Internet Engineering Task Force (IETF)'s Request For Comment (RFC) number 3775. As can be seen in FIG. 1, an IP network 100 comprises a MN 110 in communication with a CN 120 on a link that provides a direct path 122. The direct path 122 is unlikely to be composed of only one direct physical connection, but rather represents a series of links between routing equipments transparently enabling the communication therebetween. The way the series of links is used to transport traffic between the MN 110 and the CN 120 is irrelevant as long as IP communication therebetween can be established.

The MN 110 has a permanently assigned home address valid in its home network 127, which home address is allocated upon initialization of the MN 110 in the home network 127. The allocation mechanism is well-known in the prior art. The MN 110 is further in communication with a Home Agent (HA) 130 located in its home network 127. Among other functionalities, the HA 130 keeps record of a foreign address of the MN 110 valid outside the home network 127. The foreign address is called Care-of-Address (CoA) in the context of MIPv6. The CoA assigned to the MN 110 changes in time as the MN 110 moves from one network to another. The record kept by the HA 130, referred to as binding in the context of MIPv6, ties the CoA to the home address. A Binding Cache Entry (BCE) comprising the home address and the CoA of the mobile node is also kept in the CN 120 for the purpose of reaching the MN 110. The HA 130 is also responsible for routing traffic received at the home address to the MN 110. The traffic received is forwarded by the HA 120 on a link 125 toward the MN 110. All traffic sent on the link 125, in accordance with MIPv6, is encrypted to ensure, among other things, confidentiality of credentials periodically exchanged between the MN 110 and the HA 130.

The following lines summarize how the MIPv6 concept applies in a typical situation. For example, the MN 110 is in bidirectional IP communication with the CN 120 on the direct path 122. When the MN 110 moves from a first network to another, as illustrated by an arrow 135 on FIG. 1, the MN 110 receives a new CoA. This modification in addressing state of the MN 110 must be advertised to the CN 120 and the HA 130. In order to advertise modification to its CoA, the MN 110 sends a first Binding Update (BU) to the HA 130 on the link 125, which is encrypted, containing the newly acquired CoA and other information related to a binding for the MN 110 in the HA 130. The HA 130 then updates the binding and replies to the MN 110 with a first Binding Acknowledgment (BA) indicating a successful update of the binding. The MN 110, after sending the first BU, then creates a second BU similar to the first BU, and sends it to the CN 120 on the direct path 122. The CN 120, upon reception of the second BU creates a BCE, and then creates a second BA to the MN 110. Reception of the second BA at the MN 110 indicates a successful completion of the advertisement of the modification.

“Cryptographically Based Identifiers (CBID): Concepts and Applications”, ACM Transaction on Information and System Security (TISSEC), February 2004, describes how to compute an un-forgeable crypto-based identifier (CBID) for a mobile node. The CBID is statistically unique and cryptographically verifiable. The CBID can be produced using a public key (K+) and other parameters of the MN 110, as known in the art. Hence, as the CN 120 knows the K+ of the MN 110, it can verify, or authenticate, the CBID.

Multihoming allows a mobile node to configure and use multiple IP addresses at the same time. A mobile and multi-homed node (MMN) can have multiple interfaces associated to different home links. In practice, this means that multiple prefixes are advertised on the home link. By way of an example, the MMN may have access to the Internet through multiple Internet Service Providers (ISPs) and each ISP provides its own HA services). Such feature requires that the MN 110 be able to manage its pool of static/dynamic addresses. Multihoming scenario occurs when the MN 110 has multiple prefixes defined by, or associated with, either with the same HA that the MN 110 is attached to or with different HAs, or when the MN 110 has multiple interfaces, which can in turn be attached to one or different HAs. A common and practical scenario, which combines the multihoming and mobility features, is to attach multiple interfaces associated to different HAs to one MN 110. In such scenario, the MN 110 may need at some point to re-direct an ongoing session to another interface or to use one interface as a backup, while exchanging data packets on another interface. One example is to have two different interfaces providing two different access technologies attached to the mobile device. One interface may be a CDMA2000 interface connected to an operator and another Wireless Local Area Network (WLAN) interface, which can provide connectivity in a public WLAN hotspot. In such scenario, when the MN 110 is under the hotspot coverage, it may establish a real time session, for instance a Voice Over IP session, through the WLAN interface attached to the foreign network. In this case, if the MN 110 crosses the hotspot boundaries, ideally the session re-route data packets to the CDMA2000 interface.

Another scenario would consist on having two different HAs, each attached to one interface. In such scenario, performing a transfer of an ongoing session between the two HAs would require the MN 110 to update the CN 120 with two addresses, i.e., the CoA, which may or may not change as a result of the transfer, and the HoA configured on the second interface.

The MIPv6 protocol does not specify how a MN 110 can benefit from the multihoming feature in a mobile environment. According to MIPv6, the MN 110 must use a static HoA to establish the session. The only way for the CN 120 to locate a BCE in its BCE table is to search for the HoA carried by the BU. If a BU carrying a new CoA is received for an HoA, the CN 120 is capable of finding the relevant BCE and update the CoA value. However, if the mobile node changes to a new HoA, the CN 120 will not be able to locate the relevant BCE and will create a new BCE for the HoA and the corresponding CoA. As a result, no ongoing session may continue if the mobile node switches to a new HoA. Moreover, because of architectural principles of MIPv6, a session between the MN and the CN is identified with an IP address of the MN, herein the HoA, an IP address of the CN, a port number of the MN, a port number of the CN and a transport protocol therebetween. Any change in a parameter used for identification of the session will tear down the session

There would be clear advantages of having a method, a mobile node and correspondent node for providing a capability for the correspondent node to create a BCE independently from the HoA of the mobile node. This would provide for the mobile node to switch between home IP addresses while continuing an ongoing session.

### SUMMARY OF THE INVENTION

It is therefore a broad object of this invention to provide a method, a mobile node and a correspondent node for allowing setup of a session between the mobile node and the correspondent node using a new, unique indicator to enable the correspondent node to uniquely identify the mobile node. A change in the selection of a home address does not impact any ongoing session.

A first aspect of the present invention is directed to a method for setting up a session between a mobile node, served by a serving home agent, and a correspondent node. The home agent is a node in a home network wherein the mobile node has a subscription. A home address defined by the serving home agent of the home network is first selected by the mobile node. If the mobile node is currently located in a home network, this selected home address is preferred for communicating with a correspondent node. If however the mobile node is roaming in a visited network, a care-of address of the visited network is preferred as a routing address. A private identifier is calculated at the mobile node. The mobile node sends an establishment message towards the correspondent node. The establishment message comprises the private identifier and the preferred address. Responsive to the establishment message, the correspondent node creates a table entry wherein the private identifier and the preferred address.

A second aspect of the present invention is directed to a method for selecting one of a plurality of home addresses assigned to the mobile node. The mobile node having a plurality of home addresses is a mobile multihome node. The plurality of home addresses may be defined in a single home agent or in distinct home agents. The selected home address is defined by a home agent that also serves the current session for the mobile node. If more than one home addresses is defined by the home agent currently serving the session, the home address that supports a preferred access interface for the mobile node is selected among those defined by the currently serving home agent.

A third aspect of the present invention is directed to a method for updating an address in the table entry of the correspondent node. The mobile node sets a new address, the new address being used as a backup to the preferred address or being used to replace the preferred address. If the mobile node intends the new address to be used in case of a failure to reach the preferred address, the mobile node adds a backup indication. If the mobile node has moved about and has obtained a new care-of address or if it has returned from a foreign network back into the domain of a home network, the mobile node adds a mobility indication. The new address and, if set, the backup indication or the mobility indication are sent to the correspondent node in an update. The correspondent node updates the table entry, either by adding the new address as a backup address, or by substituting the preferred address with the new address, if the mobility indication was sent.

A fourth aspect of the present invention is directed to a correspondent node for receiving one or more messages for a session with a mobile node. The correspondent nodes stores in a table entry, upon receipt of a first message, a private identifier for the session and a preferred address. Upon receipt of a subsequent message carrying an alternate address, the correspondent node either adds the alternate address as a backup address in the table entry, or overwrites the preferred address in the table entry, as per an indication comprised in the subsequent update.

A fifth aspect of the present invention is directed to a mobile node comprising a mobility unit for choosing a preferred address, the preferred address being either one of a care-of address, assigned to the mobile node if it is connected to a foreign network, or a selected home address. The mobile node also comprises a computing unit for calculating a private identifier, a session management unit for setting up a session with a correspondent node and for sending address information to the correspondent node, and an interface for communicating with the correspondent node. The address information comprises the private identifier and the preferred home address.

A sixth aspect of the present invention is directed to a mobile multihome node comprising a plurality of home addresses. A selected home address is chosen based on a currently serving home agent and, if the currently serving home agent defines more than one home addresses of the mobile node, selection of the home address is based on a preferred access interface for the mobile node.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a prior art representation of a Mobile Internet Protocol version 6 architecture;

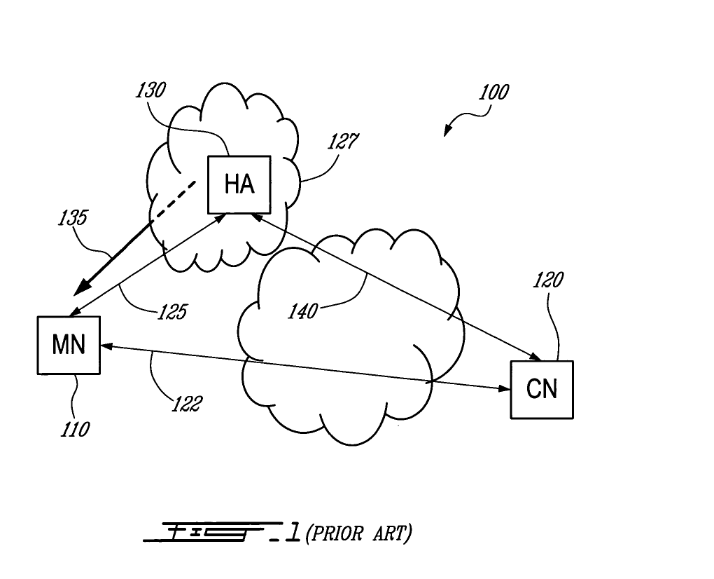

FIG. 2 shows a representation of a method to setup a session with a secret authentication key between a mobile node and a correspondent node;

FIG. 3 shows a sequence diagram of a method to assign a preferred routing address to a mobile node and to update a correspondent node;

FIG. 4 shows a sequence diagram of a method to use a home address as a backup address in case of link failure;

FIG. 5 shows a sequence diagram of a method to change a preferred routing address;

FIG. 6 shows a flow diagram of a method to select a home address at a mobile node;

FIG. 7 shows a sequence diagram of a method to update a selected home address at a correspondent node;

FIG. 8 shows an exemplary mobile node built according to the present invention; and

FIG. 9 shows and exemplary correspondent node built according to the present invention.

### DETAILED DESCRIPTION

The innovative teachings of the present invention will be described with particular reference to various exemplary uses and aspects of the preferred embodiment. However, it should be understood that this embodiment provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the description of the figures, like numerals represent like elements of the invention.

The present invention provides a method, a mobile node (MN) and a correspondent node (CN) to create at the CN a table entry for the MN, independently from the home address (HoA) of the MN.

The MN, instead of sending its HoA to the CN, sends a new unique identifier to the CN for storing in the table entry, in lieu of the HoA. A preferred address for routing messages towards the MN is also sent from the MN to the CN and stored in the table entry. The HoA may still optionally be sent to the CN, as an added field in a message that also carries the new unique identifier.

The MN may support different access technologies, for instance a cellular connection and a Wireless Local Area Network (WLAN) connection. The MN comprises an access interface for each access technology and each access interface comprises a HoA for communicating with the home agent (HA) of the home network. Further, the MN may subscribe to more than one home network and thereby be associated with more than one HA. This implies that one MN may have more than one HoA, thence becoming a mobile multihome node (MMN). The MN therefore sets up a session with the CN using one HoA corresponding to a chosen access interface, the HoA being defined in one HA, the HA itself being part of the home network that corresponds to a subscription that the MN is currently using.

In the case of Mobile IP version 6 (MIPv6), this protocol does not, without the present invention, support handoff from one access technology to another when this implies a change of HoA in the middle of a session. MIPv6 also does not handle a change of HoA when the MN selects a new HA while the session is ongoing. Through providing the new, unique identifier to identify the MN at the CN, the MN becomes free to change its HoA.

In the context of the present invention, the MN may comprise a mobile cellular telephone, a personal assistant, a laptop computer and the like, wherein the MN comprises at least one access interface and preferably supports MIPv6.

The CN may be a server, for instance a web server or a Session Initiation Protocol (SIP) server, or any computer. The CN could also be another MN, which may optionally itself be another MMN. The CN preferably supports MIPv6.

The HA may be a database in a portion of an IP network, the portion being referred to as “home network” because it provides a subscription to the MN. The HA provides a subscription to the MN by assigning a HoA to the MN.

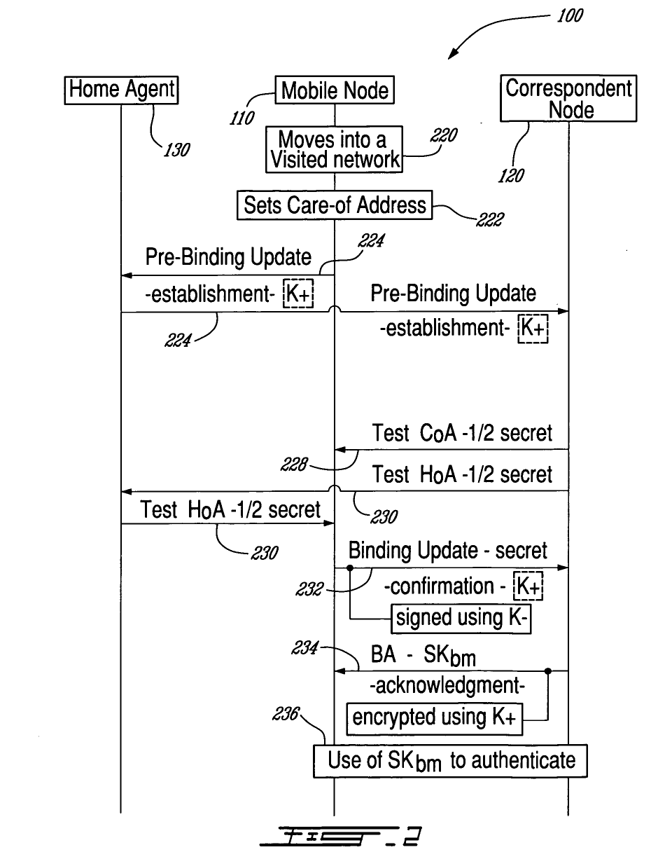

In order to provide a basis for a description of the preferred embodiment of the present invention, reference is now made to FIG. 2 which shows a representation of a method to setup a session with a secret authentication key between the MN and the CN. The MN 110 is associated with a home network, which is a home portion of the IPv6 network 100 (also referred to as home network 127). The MN 110 has a first IPv6 address or HoA valid in the home portion of the IPv6 network 100. The HoA also serves to associate the MN 110 to a Home Agent (HA) 130 located in the home network. The HA is a node in the home network wherein the MN has a subscription. When the subscription for the MN 110 is established in the home network, the HA 130 defines the HoA and allocates it to the MN 110. All traffic addressed to the HoA is first routed to the HA 130, which forwards it to the MN 110.

The MN 110 has also a pair of asymmetric keys comprising a private key (K−) and a public key (K+). The detailed functioning of double key encryption is well-known in the prior art. It is taken for granted that ownership of the K+ by the MN 110 is provable. The proof of ownership can be done, for example, using a Certificate Authority, which is a trustable third party ensuring ownership of the K+. Another solution, which does not require the use of a third party is to use the K+ already used for other cryptographic mechanisms. An example of such a mechanism is the cryptographically generated address (CGA) mechanism, which also enables proof of ownership of an IPv6 address generated therewith.

When the MN 110 moves into a visited portion of the IPv6 network 100 (step 220), a second IPv6 address or Care-of Address (CoA), valid in the visited portion, is provided to the MN 110 by a serving node of the visited portion (step 222). The CoA is set in addition to the HoA. The CoA is used to reach the MN 110 directly. The way in which the CoA is set for the MN 110 is well-known in the art.

The MN 110 needs to inform the CN 120 of its newly acquired CoA. This is achieved by sending an establishment message 224 from the MN 110 addressed to the CN 120 through the HA 130 (i.e. routed from the HA 130 towards the CN 120). The establishment message 224 may also be referred to as a Pre-Binding Update or PBU. The establishment message 224 advertises the CoA. The establishment message comprises the HoA and the CoA of the MN and, may further comprise the K+ of the MN.

Upon reception of the establishment message 224, the CN 120 tests the reachability of the CoA and the reachability of the HoA of the MN 110. This is achieved by sending from the CN 120 a first address test 228 to the MN 110 addressed to the HoA. A second address test 230 addressed to the CoA is sent from the CN 120.

Upon reception of the first address test 228 and the second address test 230, the MN 110 sends a single confirmation 232. The confirmation 232 is signed by the MN 110 using the K−. The confirmation 232 may also be referred to as a Binding Update (BU).

Reception of the confirmation 232 at the CN 120 completes the test of the CoA and HoA.

The CN 120 further sends an acknowledgement 234 to the MN 110 addressed to the CoA. The acknowledgement 234 comprises a secret authentication key (SKbm) encrypted in the acknowledgement 234 using the K+ of the MN 110. The SKbm is likely to be generated by the CN 120. The acknowledgement 234 may also be referred to as a Binding Acknowledgment (BA). Upon reception of the acknowledgement 234, the MN 110 decrypts the SKbm using the K−. Thereafter, both the CN 120 and the MN 110 have the same SKbm to authenticate the communication therebetween at step 236.

The K+ of the MN 110 may be advertised either by sending the K+ in the establishment message 224, in the confirmation 232, or in any combination of messages 224 and 232.

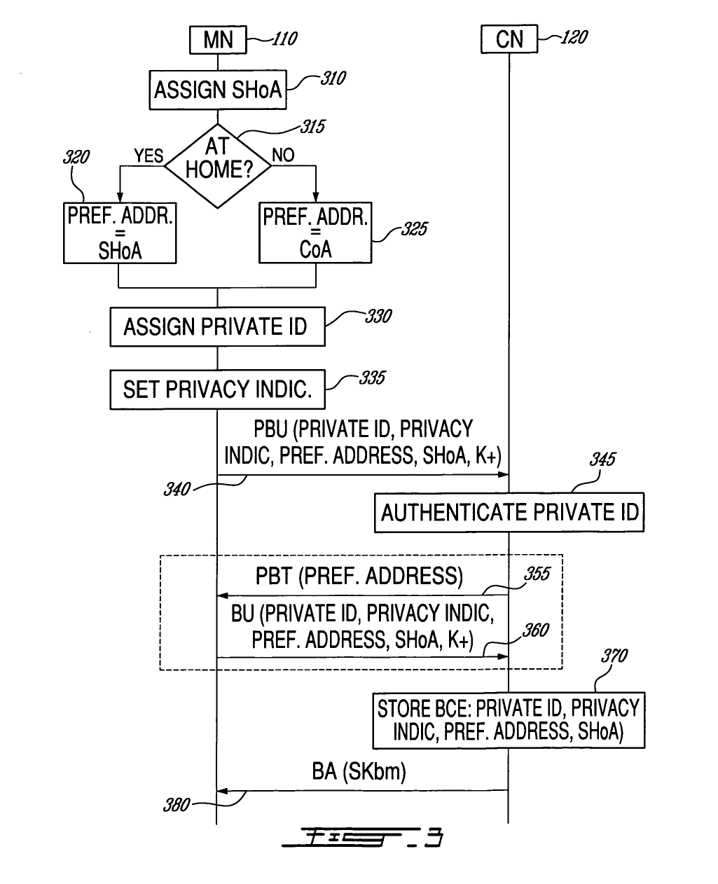

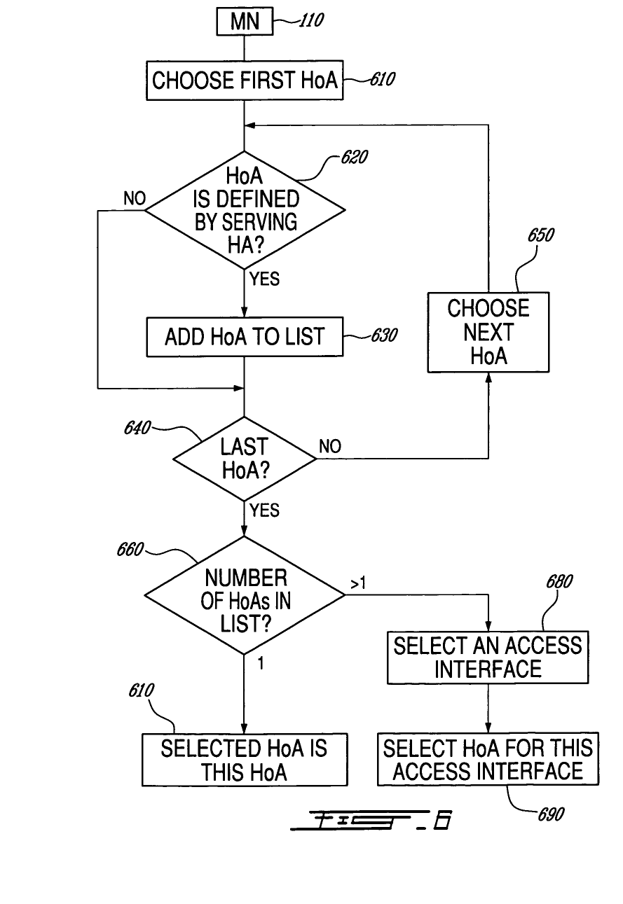

Having now described hereinabove a general method of setting up a session between the MN and the CN, an exemplary aspect of the preferred embodiment of the present invention will now be described by reference to FIG. 3, which shows a sequence diagram of a method to assign a preferred routing address to the MN 110 and to update the CN 120. Within the MN 110, the HoA is assigned for setup of a session with the CN 120 at step 310. FIG. 6 below describes a process whereby one amongst a plurality of HoAs is assigned as a Selected Home Address (SHoA). For the purposes of the present description of step 310, it may be assumed that the MN 110 comprises a single HoA, which is automatically construed as the SHoA. This exemplary case of a MN 110 with one single HoA is not meant to limit the scope of the present invention, but is presented for clarity purposes.

At step 315, it is determined whether the MN 110 is currently located within the home network 127. If it is within the home network, the SHoA is assigned as a preferred address, to be used for routing traffic towards the MN 110, at step 320. If however the MN 110 is not located within the home network 127, the MN 110 is accessing a foreign or visited network. The visited network allocates a CoA to the MN 110. Allocation of the CoA is well-known to those of ordinary skills in the art and is outside the scope of the present invention. Those familiar with the art of IP communication know that the HA serving the MN 110 is made aware of the CoA allocated to the MN 110. In this case where the MN 110 is visiting a foreign network, the CoA is assigned as the preferred address at step 325.

A private identifier is assigned to the MN at step 330. The private identifier is used as a means to let the CN 120 identify the mobile station independently from the SHoA. The private identifier is not an IP address and it cannot be used for routing. Ideally, the private identifier is encrypted in a manner that will permit authentication of the MN. The private identifier is preferably a crypto-based identifier (CBID), calculated as described in “Cryptographically Based Identifiers (CBID): Concepts and Applications”, ACM Transaction on Information and System Security (TISSEC), February 2004. At step 335, the MN 110 sets a privacy indication used to indicate that the private identifier may not be used as a routing address. The private identifier, the preferred address and, optionally, the privacy indication the SHoA and a public key (K+) of the MN are sent to the CN 120 in the establishment message at step 340. In the context of an MIPv6 implementation, the establishment message takes the form of the PBU.

The CN 120 receives the establishment message at step 340. If the private identifier is of the CBID type, the CN 120 may authenticate at step 345 the establishment message by recomputing the CBID, by use of the K+, to match the value received in the establishment message. The CN 120 detects from the privacy indication that the private identifier is not a routable address, it thus does not attempt to test the routability of the private identifier. In an alternate embodiment wherein the privacy indication is not included in the establishment message, the CN 120 may analyze the format or the value of the private identifier and determine that this is not a routable address. In yet another embodiment wherein the privacy indication is not included in the establishment message, the CN 120 may attempt to send a message, for example the address test shown at step 230 on FIG. 2, using the private identifier as a routing address, detect that no response is received or that an error message is received, and thereby determine that the private identifier is not a routable address.

The CN 120 may optionally test the routability of the preferred address by sending an address test to the MN 110 on the direct path 122, at step 355. In the context of an MIPv6 implementation, the address test is a Pre-Binding Test (PBT). The MN 110 then replies to the address test by sending a confirmation, to the CN 120, at step 360. The content of the confirmation is similar to that of the establishment message. In the context of an MIPv6 implementation, the confirmation takes the form of the BU. The CN 120 may verify the CBID included in the confirmation (not shown) in the same manner as described at step 345. Upon receipt of the confirmation, or upon receipt of the establishment message if steps 355 and 360 are not supported, the CN 120 creates a table entry for the session, preferably a Binding Cache Entry (BCE), at step 370. The BCE is comprised, for example, in a table within the CN 120. According to the teachings of the present invention, the private identifier is used as a pointer to locate a specific entry in the table. The entry created at step 370 for the session with the MN 110 comprises generally the information received in the establishment message or in the confirmation, namely the private identifier and the preferred address and, optionally, the privacy indication, the SHoA and the K+. The CN 120 calculates the SKbm and returns it to the MN 110 in an acknowledgement, preferably in the BA in the case of MIPv6, at step 380.

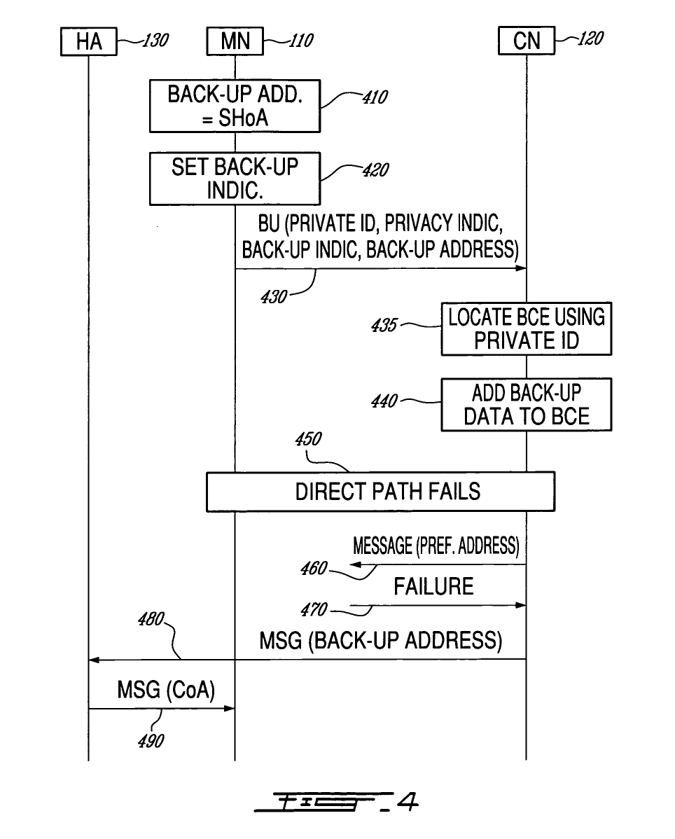

The session having been set up using the exemplary method of FIG. 3, various events may happen during the session. Another aspect of the preferred embodiment of the present invention will now be described by reference FIG. 4, which shows a sequence diagram of a method to use a HoA as a backup address in case of link failure. The steps described herein usually take place after a session between the MN 110 and the CN 120 has been set up as described earlier. In the context of FIG. 4, the MN 110 is located in a visited network, or foreign network, and the preferred address is a CoA. At step 410, the MN 110 determines that its SHoA shall be used as an alternate address for backup purposes, in case of a failure to communicate on the direct path 122 between the CN 120 and the MN 110. Alternatively, another address might be selected as a backup address by the MN 110. At step 420, the MN 110 sets a backup indication. An update, which in the case of MIPv6 takes the form of a new BU, is sent from the MN 110 to the CN 120 at step 430, the update comprising the private identifier, the privacy indication, the backup indication and the alternate address. Optionally, the CN 120 authenticates the private identifier of the update, in the same manner as described earlier. The private identifier received in the update is used at the CN 120 to locate the table entry for the session, the table entry being a BCE if the CN 120 is made to support MIPv6, at step 435. At step 440, responsive to the backup indication received as a content of the update, the CN 120 adds the alternate address as a backup address in the table entry. At step 450, the direct path 122 between the MN 110 and the CN 120 fails. This event is not necessarily immediately detected by either of these 2 nodes or either controlled thereby. At step 460, the CN 120 attempts to send a message of any nature relevant to the current session to the MN 110, using the preferred address. At step 470, the CN 120 receives a failure indication. As explained earlier, the direct path 122 is unlikely to be composed of only one direct physical connection, but rather represents a series of links between routing equipments transparently enabling the communication therebetween. Hence, anyone of the routing equipments may generate the failure indication. The means for generating the failure indication is well-known in the art and is outside the scope of the present invention. Responsive to the failure indication, the CN 120 resends the same message it intended to send at step 460, but this time using the backup address, at step 480. In the present exemplary use, the backup address is in fact the SHoA of the MN 110. Hence, the HA 130 of the MN 110 receives the message at step 480. Because the HA 130 has a knowledge of the CoA of the MN 110, it forwards the message and its content to the MN 110 by use of the CoA at step 490.

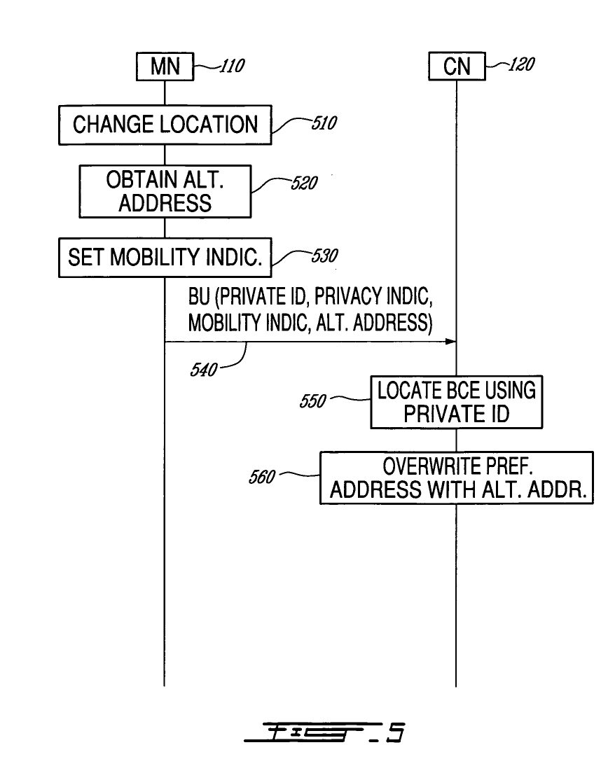

Having set up the session using the exemplary method of FIG. 3, the MN 110 may change location during the session. A further aspect of the preferred embodiment of the present invention will now be described by reference to FIG. 5, which shows a sequence diagram of a method to update the preferred address of the MN 110 in the table entry, or BCE, of the CN 120. The change of preferred address may be required when the MN 110 changes location at step 510. The MN 110 may move into a new foreign network and obtain a new CoA. In this case, the CoA becomes an alternate address at step 520. The MN 110 may also move away from a foreign network, back into its home network. In the case where the MN 110 returns home, the SHoA becomes the alternate address at step 520. In either cases, the MN 110 sets at step 530 a mobility indication indicating that the alternate address is chosen as a result of a change of location of the MN 110. The MN 110 sends, at step 540, an update, for example a new BU, comprising the private identifier, the privacy indication, the mobility indication and the alternate address. The CN 120 receives this update and optionally authenticates the private identifier. At step 550, the CN 120 identifies the table entry, by finding the specific entry comprising the received private identifier. At step 560, responsive to the mobility indication, the CN 120 overwrites the preferred address of the MN 110 in the table entry with the received alternate address. Thereafter, the CN 120 uses the new preferred address stored in the table entry to communicate with the MN 110.

In a still further aspect of the invention, a mobile and multi-homed node (MMN) can have multiple interfaces associated to different home links. The MN 110 used in the exemplary method as described in FIG. 3 may be extended to become the MMN. FIG. 6 shows a flow diagram of a method to select the HoA at the MN. The MN 110 of FIG. 6 is a MMN. This MMN comprises a table which includes a plurality of HoAs. The plurality of HoAs may be defined by, or associated with, one single HA. Alternatively, various HoAs may be defined by, or associated with, a plurality of HAs. The table defines an association with one single HA for each HoA. The SHoA must be served by the HA that also serves the current session for the MN. Otherwise stated, by selecting one HoA as the SHoA for the session, the MN automatically selects the serving HA that defines the SHOA.

If more than one HoA is associated with, is defined by, the HA currently serving the session, the HoA that supports a preferred access interface for the MN needs to be selected among those HoA defined by the currently serving HA. To assign the SHoA for a session, the MN 110 must consider all HoAs within its table that are associated with a serving HA for the session. This process is described within FIG. 6. At step 610, the MN 110 chooses a first HoA within its table. At step 620, the MN 110 verifies whether or not the first HoA is associated with the serving HA. If so, the first HoA is added as a candidate HoA to a list at step 630. Whether or not the first HoA was added to the list, step 640 checks if this was the last HoA in the table. If not, the next HoA is chosen at step 650 and step 620 is repeated for this next HoA. Eventually, at step 640, it is found that the last HoA in the table has been verified. At step 660, the number of candidate HoAs in the list is verified. Because the MN 110 can only be served by a HA that defines at least one of its HoAs, the number of candidate HoAs in the list cannot be less than unitary at step 660. If, at step 660, it is found that there is a single candidate HoA in the list, this candidate HoA is assigned as the selected HoA, or SHoA, at step 670. There could be more than one candidate HoA in the list found at step 660. This would be the case where, for instance, the MN 110 comprises a WLAN access interface and a CDMA2000 access interface, both of these interfaces being served by a same HA through distinct HoAs. In this case, the MN 110 chooses a preferred access interface at step 680. The preferred access interface selection may be based on user preference, on signal strength of signals received on both access interfaces, or on other considerations such as a distinct tariff for each of the access interfaces. At step 690, the MN 110 assigns, from the list, a candidate HoA for the preferred access interface as the SHoA for the session.

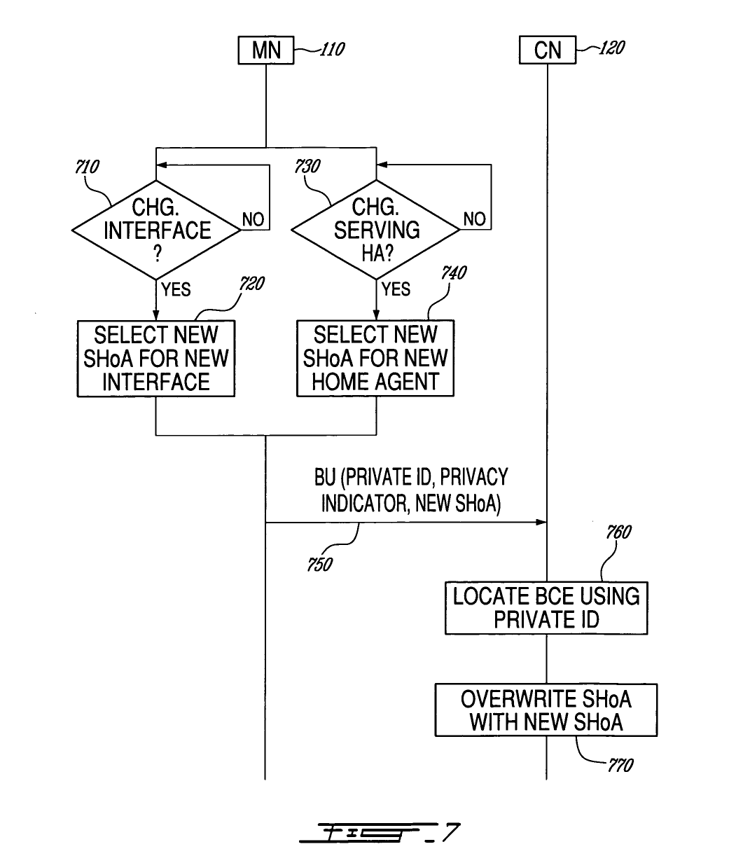

The exemplary method as described in FIG. 3 may be extended to support the MMN of FIG. 7. A variant of the exemplary method of FIG. 3, wherein the MMN is in a session with the CN, will now be described by reference to FIG. 7, which shows a sequence diagram of a method to update the SHoA at the CN. The steps described herein usually take place after a session between the MN 110 and the CN 120 has been set up as described earlier, wherein the SHoA was actually sent by the MN 110 to the CN 120 and stored in the table entry for the session. At step 710, the MN 110 changes its access interface. This may happen, for instance, as a user of MN 110 walks away from a WLAN coverage area and intends to continue an ongoing session. The MN 110 needs to use a new preferred access interface, for instance a CDMA2000 interface. At step 720, the MN 110 selects a new SHoA for the new access interface. Alternatively, at step 730, the MN 110 may select a new HA. This could happen, for instance, as the user moves from a first home network to a second home network served by a second HA. Depending on charging issues, it may be more economical for the MN to be served by the second HA rather than receiving a CoA in the second home network while still using the SHoA of the first home network. At step 740, the MN 110 selects a new SHoA associated with the second HA. If the MN 110 has only one HoA associated with the second HA, this one HoA is selected. If however the MN 110 has more than one HoA associated with the second HA, the process of FIG. 6 may be applied in the MN 110 to choose the SHoA.

Whether the new SHoA was selected in step 720 or in step 740, the new SHoA is distinct from any SHoA previously announced to the CN 120 in an earlier confirmation or in an earlier update. The MN 110 sends a new update to the CN 120 at step 750. The new update comprises the private identifier, the privacy indicator and the new SHOA. At step 760, the CN 120 identifies the table entry for the session by finding the specific entry comprising the newly received private identifier. The CN 120 updates the table entry for the MN 110 by overwriting the SHoA value with the newly received SHoA at step 770.

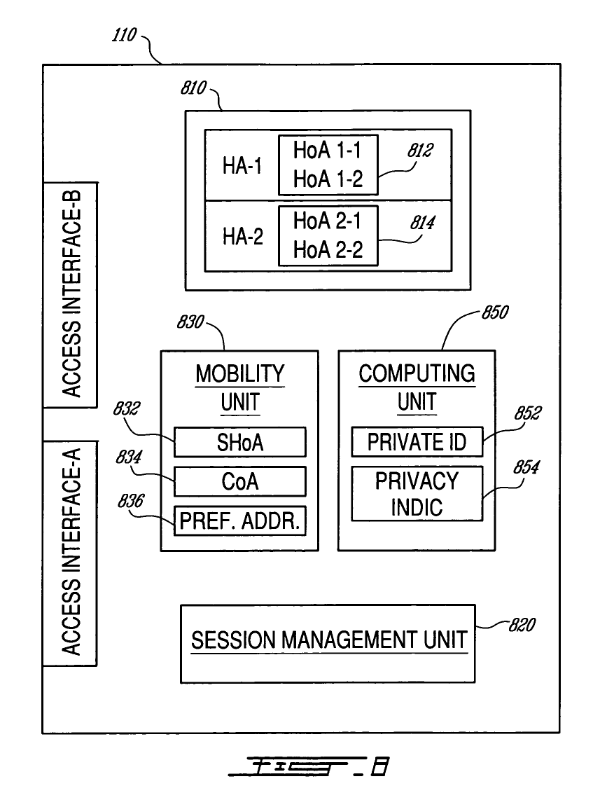

An exemplary construction of an MN 110 as used in the preceding figures, will now be described by reference to FIG. 8, which shows an exemplary MN 110 built according to the present invention. The MN 110 may be implemented in hardware, software, or any combination thereof. The MN 110 comprises at least one access interface-A, used to communicate with CNs through a connection to home networks and, when away from a home network, through a connection to foreign networks. The MN 110 may further comprise a second access interface-B. In an exemplary MN 110, access interface-A might be a CDMA2000 interface and access interface-B might be a WLAN interface. Those of ordinary skills in the art will understand that other access interfaces might also be supported by the MN 110 of the present invention, comprising, by way of examples, a Wideband Code Division Multiple Access interface, a General Packet Data Service interface, a WiMAX interface, a EV-DO interface, and the like.

The MN 110 comprises a table 810 comprising at least one HoA. If the MN 110 is a MMN, it comprises a plurality of HoAs.

The table 810 forms a mapping of associations of the MN 110 with one or more HAs. The table 810 comprises the identity of one or more HAs and further comprises associations of one ore more HoA to at least one HA, for instance HA-1 and HA-2. For each HA in the table 810, there is at least one HoA, for instance HoA1-1 and HoA1-2, which are defined by, or associated with HA-1, and HoA2-1 and HoA2-2 are defined by, or associated with HA-2. In the exemplary MN 110 of FIG. 8, two access interfaces are provided and the MN 110 comprises one HoA for each access interface supported by each of the two HAs. For instance, HoA1-1 is defined by HA-1 and uses access interface-A. Other arrangements would also be possible. In a simpler case, the MN would have a single access interface and a single HoA defined by one HA; for this exemplary MN, the table 810 would comprise a single HA identity and a single HoA associated therewith. This MN would not be a multihome node, but would still benefit from many of the advantages of the present invention. Another MN could have a single access interface and access to two HAs. A third MN could have two access interfaces and access to only one HA. A fourth MN could have two access interfaces, each of which providing access to one or the other of two HAs.

The MN 110 further comprises a session management unit 820, a mobility unit 830 and a computing unit 850. The session management unit controls sessions with the CNs, sends establishment messages, updates and confirmations, and receives address tests and acknowledgements through the access interfaces in use during the sessions. The mobility unit 830 handles addresses for MN 110. It comprises a SHoA memory 832 for storing the selected HoA, a CoA memory 834 for storing a care-of address, and a preferred address memory 836 for storing the address that is preferred for routing. The mobility unit 830 detects a location of the MN 110 by determining whether or not the MN 110 is connected to a home network. If a foreign network is being visited, the mobility unit 830 acquires the CoA in the well-known manner. The mobility unit 830 further assigns the SHOA. To assign the SHOA, the mobility unit 830 considers elements of the table 810. If there is only one single HoA in the table 810, this HoA is the SHoA. If more than one HoA is present in the table 810, the mobility unit 830 needs to identify the serving HA. The mobility unit 830 considers whether there is one or more HAs defined in the table 810. If the table 810 comprises a single HA identity, the MN 110 is currently being served by this HA. Otherwise, the mobility unit 830 identifies the serving HA by finding which of the HAs corresponds to the ongoing session. Once the serving HA is identified, if table 810 comprises only one HoA served by the serving HA, this HoA is the SHOA. If there is more than one HoA served by the serving HA, one of the HoAs that is assigned for a preferred access interface of MN 110 for this session becomes the SHoA. The mobility unit 830 yet further selects the preferred address between the SHoA and the CoA, and sets backup indications and mobility indications. The computing unit 850 calculates the private identifier 852 and sets the privacy indicator 854. Preferably, the computing unit 850 uses a K+ (not shown) of the MN 110 to calculate the private identifier 852 in the format of the CBID. Messages exchanged between the MN 110 and the CN 120 to transfer information such as the SHOA, the preferred address, the private identifier and the various indications are sent through one of access interface-A or access interface-B, one of the access interfaces being selected according to user interface, to availability of a signal on those access interfaces and on other considerations.

Each of the table 810, session management unit 820, the mobility management unit 830 and the computing unit 850 may be implemented in many ways including, but not limited to, hardware, software, firmware or combination thereof.

When the session management unit 820 of the MN 110 initially establishes a new session with the corresponding node, the session management unit 820 selects one access interface-A or access interface-B. The selection of an access interface is outside the scope of the present invention and is well-known in the art. The session management unit 820 may also determine which of the HAs, if the MN 110 has more than one subscription, currently serves the MN 110. Section of a serving HA, either HA-1 or HA-2, based on for example billing considerations or on the current location of the MN 110. Selection of the which HA serves the MN is also known in the art. The mobility unit 830 selects the home address that corresponds to the chosen access interface and to the chosen HA in a SHoA memory 832. If the MN 110 is outside of the home network that comprises the serving HA, the mobility unit 830 acquires a CoA from a foreign network. The mobility unit 830 stores the CoA in the CoA memory 834. The mobility unit 830 then selects the CoA, if one was assigned, or the SHoA, if no CoA was assigned, and stores it in the preferred address memory 836. The computing unit 850 calculates the private identifier and stores it in the private identifier memory 852. It also stores a privacy indicator in the privacy indicator memory 854. The session management unit 820 reads the preferred address memory 836 and the SHoA memory 832 of the mobility unit 830, as well as the privacy indicator memory 854 and the privacy indicator memory 854 of the computing unit 850. The session management unit 820 builds the establishment messages and the updates using the values of the preferred address memory 836, the private identifier 852 and, optionally, the SHoA memory 832 and the privacy indicator memory 854. The session management unit 820 sends the update and establishment messages by use of the access interface currently in use for the session. The session management unit receives the address test and the acknowledgement via the access interface currently in use.

During the session, if a new CoA is assigned, or if the MN 110 enters the home network from the foreign network, the mobility unit 830 updates its preferred address memory 836. If the session management unit 820 selects a new serving HA or a new access interface, the mobility unit 830 updates its SHoA memory 832. In either cases, the session management unit 820 reads the updated preferred address memory 836 or the updated SHoA memory 832, as applicable, of the mobility unit 830, initiates sending an update to the CN. The session management unit 820 may also autonomously initiate an update to the CN, comprising the SHoA memory 832 value read from the mobility unit 830, and a backup indication.

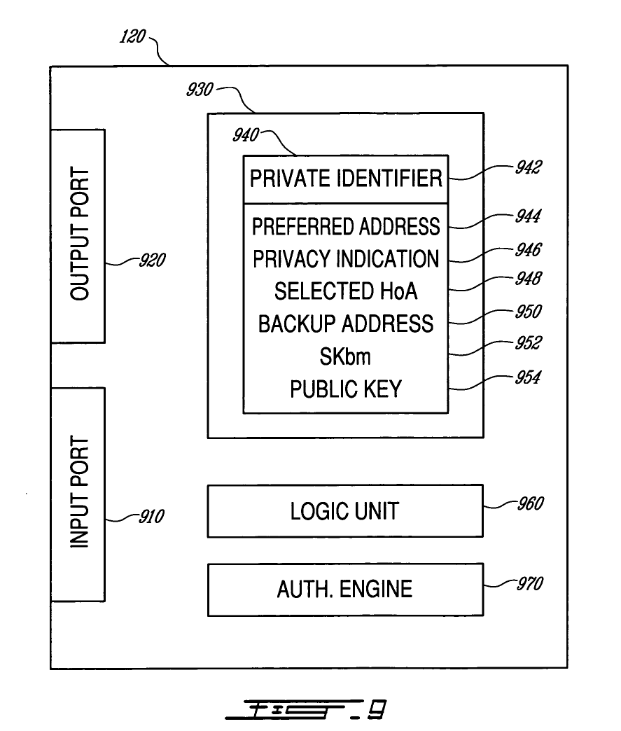

An exemplary construction of a CN 130 as used in the preceding Figures, will now be described by reference to FIG. 9, which shows and exemplary CN 120 built according to the present invention. The CN 120 may be implemented in hardware, software, or any combination thereof, as is well known in the art. The CN 120 comprises an input port 910 for receiving messages such as the establishment message, the confirmation, the update, the PBU or the BU and an output port 920 for sending messages such as the address test, the acknowledgement, the PBT or the BA. Depending on the access technology used by the CN 120, the input port 910 and the output port 920 may form one single entity. The CN 120 further comprises a table 930 comprising entries 940, which may be for example BCEs, and a logic unit 960 for analyzing the content of received messages, for sending messages according to a preferred address for a session and for managing sessions. One entry 940 is created for each session with one of the MNs 110, each entry comprising as a minimum a private identifier 942 and a preferred address 944. To locate one of the entries 940 for handling data received in a message, the logic unit 960 scans through the table 930 and searches for one entry 940 comprising the private identifier 942 that matches a private identifier received as a part of the message. When no match is found, this is a first message for a new session and the logic unit 960 initiates creation of a new entry 940.

The establishment message, the confirmation or the update may comprise additional fields such as a SHoA field, a privacy field, and a K+ field. If those fields are received, the logic unit 960 orders the entry 940 to store the fields as a SHoA 948, as privacy indication 946, and as public key 954. If the K+ filed is received, the logic unit 960 may further calculate a SKbm 952.

A further message received from the MN 120, for example an update, may comprise indicators, such as a backup indication or a mobility indication, along with an alternate address. The logic unit 960 detects and analyses such indications. If the mobility indication is received as a part of the update, the logic unit 960 orders the entry 940 to overwrite the preferred address 944 with the alternate address provided in the update. If the logic unit 960 detects a backup indication in the update, the logic unit 960 orders the entry 940 to store the alternate address as a backup address 950.

The CN 120 further comprises an authentication engine 970 that is capable of authenticating the private identifier received in the message by use of the public key 954. Those of ordinary skills in the art will appreciate that where the private identifier is used separately from a HoA to identify the entry 940, a change of SHoA does not lead the CN 120 to create a new entry 940. Instead, a message that comprises a private identifier known to the CN 120 and a new SHoA is correctly used by the CN 120 to overwrite the SHoA 948 value in the entry 940 with the newly received SHoA value.

Although several aspects of the preferred embodiment of the method, of the mobile node and of the correspondent node of the present invention have been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

1. A method for setting up a session between a mobile node, served by a serving home agent of a home network, and a correspondent node, the method comprising the steps of:
assigning at said mobile node a selected home address defined by said serving home agent;
assigning at said mobile node a preferred address, wherein
said preferred address is said selected home address if said mobile node is located within said home network, and
said preferred address is a care-of address if said mobile node is located within a visited network;
assigning a private identifier at said mobile node;
sending an establishment message from said mobile node towards said correspondent node, wherein said establishment message comprises said private identifier and said preferred address; and
creating at said correspondent node a table entry for said session, said table entry comprising said private identifier and said preferred address, wherein said private identifier is used at said correspondent node to identify said session.

2. The method according to claim 1, wherein:
said mobile node comprises a plurality of home addresses.

3. The method of claim 2, wherein:
all of said plurality of home addresses are defined by said serving home agent; and
said mobile node comprises an association of said plurality of home addresses with said serving home agent.

4. The method of claim 2, wherein:
at least one of said plurality of home addresses is defined by said serving home agent, said mobile node comprising an association of said at least one of said plurality of home addresses with said serving home agent; and
at least another one of said plurality of home addresses is defined by a second home agent, said mobile node comprising an association of said at least another one of said plurality of home addresses with said second home agent.

5. The method of claim 2, further comprising the steps of:
making at said mobile node a list of one or more candidate home addresses among said plurality of home addresses wherein all candidate home addresses within said list are associated with said serving home agent; and
if said list comprises only one candidate home address, assigning said candidate home address as said selected home address, and
if said list comprises more than one candidate home address, assigning one of said list of one or more candidate home addresses as said selected home address according to a preferred mobile node access interface for said session.

6. The method of claim 2, wherein:
said establishment message further comprises said selected home address and a privacy indication to indicate that routing towards said private identifier is not permitted; and
said table entry further comprises said selected home address and said privacy indication.

7. The method of claim 6, further comprising the step of:
assigning one of said plurality of home addresses as a second selected home address according to a change of a preferred access interface for said session.

8. The method of claim 7, further comprising the steps of:
sending from said mobile node an update, said update comprising said private identifier, said privacy indicator, and said second selected home address;
identifying at said correspondent node said table entry by use of said private identifier; and
updating at said correspondent node said table entry by replacing said selected home address with said second selected home address.

9. The method of claim 1, further comprising the steps of:
before creating said table entry, using said preferred address for sending an address test from said correspondent node towards said mobile node; and
responsive to said address test, sending a confirmation from said mobile node to said correspondent node, said confirmation comprising said private identifier and said preferred address.

10. The method of claim 9, wherein:
said private identifier is a cryptographically based identifier; and
said correspondent node authenticates said establishment message and said confirmation according to a value of said cryptographically based identifier.

11. The method of claim 10, further comprising the step of:
responsive to said confirmation, sending from said correspondent node an acknowledgement to said mobile node.

12. The method of claim 11, wherein:
said acknowledgement comprises a secret authentication key.

13. The method of claim 1, further comprising the steps of:
sending from said mobile node an update, said update comprising said private identifier, a backup address and a backup indication;
wherein:
said preferred address is a care-of address,
said backup address is said selected home address, and
said backup address is used by said correspondent node to send a message towards said mobile node if said preferred address is not reachable.

14. The method of claim 1, further comprising the steps of:
sending from said mobile node an update, said update comprising said private identifier, an alternate address and a mobility indication;
wherein:
said update is responsive to a location change of said mobile node,
said alternate address is either said selected home address or a new care-of address,
said alternate address overwrites said preferred address in said table entry, and
said alternate address is used by said correspondent node to send any further message to said mobile node.

15. A correspondent node, comprising:
an input port for receiving a message, said message comprising a private identifier for a session and a preferred address of a mobile node; and
a table for storing an entry for said session, wherein
said entry in said table comprises said private identifier and said preferred address, and
said private identifier is for identifying said session.

16. The correspondent node of claim 15, wherein:
said message further comprises a selected home address.

17. The correspondent node of claim 16, wherein:
said input port is for further receiving an update, said update comprising an additional address; and
said table is for storing said additional address in said entry.

18. The correspondent node of claim 17, wherein:
said table is for overwriting said selected home address with said additional address in said entry when said additional address is a new selected home address.

19. The correspondent node of claim 17, wherein:
said update further comprises a mobility indication; and
said table is for overwriting, responsive to said mobility indication, said preferred address with said additional address in said entry.

20. The correspondent node of claim 17, wherein:
said additional address is a backup address;
said update further comprises a backup indication; and
said table is for storing, responsive to said backup indication, said backup address in said entry.

21. The correspondent node of claim 15, wherein:
said establishment message further comprises a privacy indication for indicating that routing to said private identifier is not permitted.

22. A mobile node for setting up a session with a correspondent node, said mobile node comprising:
an access interface for communicating with said correspondent node;
a mobility unit for assigning a home address as a selected home address, for acquiring a care-of address if said mobile node is not connected to a home network, and for choosing a preferred address, said preferred address being set equal to:
said care-of address if said mobile node is not connected to said home network, and
said selected home address if said mobile node is connected to said home network;
a computing unit for calculating a private identifier; and
a session management unit for controlling said session, for receiving said preferred address from said mobility unit, for receiving said private identifier from said computing unit, and for sending through said access interface said private identifier and said preferred address towards said correspondent node.

23. The mobile node of claim 22, further comprising:
a table for storing identities of one or more home agents and for storing a first home address and a second home address, said first home address being associated with a first home agent and said second home address being associated with one of said first home agent and a second home agent;
wherein said mobility unit assigns said selected home address amongst said first home address and said second home address.

24. The mobile node of claim 23, wherein:
if said first home address and said second home address are associated with distinct home agents:
said mobility unit is configured for choosing said first home address as said selected home address if said mobile node is served by said first home agent,
said mobility unit is configured for choosing said second home address as said selected home address if said mobile node is served by said second home agent; and
if said first home address and said second home address are both associated with the first home agent:
said mobility unit is configured for choosing one of said first home address and said second home address as said selected home address according to said access interface wherein said access interface is preferred for said session.

25. The mobile node of claim 24, wherein:
said mobility unit is configured for choosing one of said first home address or said second home address as a second selected home address at said mobile node, wherein said second selected home address is not the same as a previously selected home address.

26. The mobile node of claim 25, wherein:
said mobility unit is configured for choosing said second selected home address according to a change of a serving home agent for said session.

27. The mobile node of claim 25, wherein:
said mobility unit is configured for choosing said second selected home address according to a change of a preferred access interface for said session.

28. The mobile node of claim 25, wherein:
said session management unit is for receiving said second selected home address from said mobility unit and for sending said second selected home address and said private identifier through said access interface towards said correspondent node.
